(19) United States
(12) Patent Application Publication
(10) Pub. No.: US 2023/0205490 A1
(43) Pub. Date: Jun. 29, 2023

(54) Entanglement Quantum Random Number Generator with public randomness certification

(71) Applicant: COMPSECUR SP. Z O.O., Wroclaw (PL)

(72) Inventors: Janusz JACAK, Wroclaw (PL); Witold JACAK, Wroclaw (PL); Wojciech DONDEROWICZ, Wroclaw (PL); Lucjan JACAK, Wroclaw (PL)

(21) Appl. No.: 16/957,489

(22) PCT Filed: Dec. 31, 2017
(86) PCT No.: PCT/PL2017/000133

§ 371 Date: Jun. 24, 2020

(30) Foreign Application Priority Data
Dec. 30, 2017 (PL) P.424145

(51) Int. Cl. G06F 7/58; G06N 10/20

(52) U.S. Cl. CPC G06F 7/588; G06N 10/20

(57) ABSTRACT

As the quantum random number generators are gaining in popularity, especially with regard to possibility of construction of a scalable quantum computer, a new invention is proposed in this area based upon topological properties of quantum entanglement. The proposed Entanglement Quantum Random Number Generator (Entanglement QRNG) uses a certain multi-qubits entanglement of quantum states to produce randomness with public certification. The invention describes both the protocol and its generic implementing device, involving the specific 3-qubits quantum entanglement of generalized Bell state type (topologically inequivalent to different types of entanglements and easily generalized to multiple-qubits as shown in the invention description), characterized also in the topological terms, that enables private quantum random number generation with a publicly accessible proof of randomness, thus allowing an external party to freely and publicly verify the randomness of the generated sequence without disclosing of its secrecy or distorting it in any way (this feature of QRNG is proposed for the first time and has an important role for applications in both quantum and classical cryptography).

### TECHNICAL FIELD

Random Number Generator (RNG) is a device that produces random numbers, usually encoded as sequences of bits 0 and 1 constituting a logical framework of computer and communication architectures.

Random Number Generators in principle can be divided into two classes: the Pseudo RNGs (PRNGs) and True RNGs (TRNGs) depending on the physical process of random number generation. Most of the currently used RNG devices are based upon deterministic processes and classical (deterministic) chaos, that is the generation of randomness is based upon classical physics laws. In this case, in PRNGs randomness is not true, but is fully dependent on the complexity of the system involved in physical process of randomness generations and in principle can be predicted with sufficient knowledge of initial conditions regarding the physical system and computational power to simulate its behavior. As the macroscopic systems constituting such PRNGs devices undergo classical physics behaviour which is deterministic, even if very complex and seemingly unpredictable, a sufficiently complex technology can in principle measure the physical evolution of RNGs and it's interaction with the environment and thus predict the produced random sequence. An example of PRNGs are classical computer processors which can generate pseudo random sequences in relation to their deterministic operation within complex algorithms (the algorithm is fed with a seed number which is then processed in a complex manner providing new pseudo-random number).

The other class of Random Number Generators are True RNGs in which the randomness is absolute. The notion of absolute randomness is strictly equivalent to nondeterministic evolution of physical systems that constitute TRNGs. However truly nondeterministic evolution is characterizing only quantum physical systems and in more precise terms it is present only in the measurement of those quantum system states. Therefore True RNGs are indeed equivalent with so called Quantum RNGs, which describe class of RNGs in which generation of absolute, i.e. unbiased and unpredictable randomness is based upon the fundamental laws of quantum mechanics, rather than of classical physics.

It is important to add that sometimes another division of RNG classes is used: differentiating Software against Hardware RNGs. The classically understood Software RNGs (SRNGs) operate on deterministic information processing devices (for example classical computers or other electronic appliance chips) and thus are always PRGNs, however one can also think about SRNGs based on algorithms for quantum computer and such SRNGs will therefore be able to provide truly randomness, becoming TRNGs (or in fact QRNGs). On the other hand Hardware RNGs (HRNGs) are devised based solely on physically implemented processes, instead of algorithmic information processing, and as such can be either PRNGs (if they are based on deterministic classical systems) or TRNGs/QRNGs (if based on nondeterministic, truly random processes, i.e. on quantum processes). Therefore the proper and meaningful distinction between RNGs is either they are classical (pseudo-random: PRNGs) or quantum (truly-random: TRNGs/QRNGs).

Physical evolution of quantum systems can be either unitary or non-unitary if the system leaves its pure (normalized) state configuration and becomes a mixed subsystem of a larger the entangled complex system. As opposed to the unitary evolution (or conversingly the process of changing of bases, which might be considered a subjective property of the classical observer) the entanglement between subsystems of a larger complex quantum system (e.g. of 2 qubits) posses a qualitative advantage as a new informational resource and indeed possesses non-classical property (violating the local realism assumptions). Entanglement between the components of the complex systems (e.g. between the two qubits) is due to their superposition becoming inseparable in terms of tensor product of states belonging to Hilbert spaces of both subsystems (qubits), which resolves to a non-unitary evolution of each qubit (altogether they evolve unitarily in joint Hilbert space and a complex system remains pure in this space which is just a matter of alternative formulation in changing of the bases—i.e. a subjective process dependent on the observer making measurement upon the joint Hilbert space, but what is most important is that the subsystems become entangled and mixed upon leaving normalized pure states and their own respective normalized Hilbert spaces). Within this situation vector states formalism is thus not sufficient anymore to describe each qubit (as they are not normalized) and the density matrix formalism is required as a resort to describe the mixed state (the mixed states being the reduced density matrices of the complex system, i.e. a density matrices traced over degrees of freedom of the remainings of the complex system). For the pure state the density matrix is a projection operator to this pure state, while for the mixed state it becomes after this reduction a probability mixture of the pure states (i.e. an entangled mixed state resides with given probabilities in the relevant pure states—hence the name of the mixed state). To prove that the reduced density matrix describing the mixed states is a probabilistic mixture, one needs to refer to the density matrix properties (that are easily proven themselves) stating that density matrices are hermitian, not negatively-valued and have their traces equal to 1. From this it follows upon the spectral decomposition theorem that each density matrix can be diagonalized and decomposed into linear combination of projection operators towards the eigenvectors (or subspaces spanned by them in case of degeneration) and with corresponding eigenvalues which are real numbers (hermitian property), such however that are limited from 0 to 1, and all sum to 1 (respectively from the properties of density matrices being non-negatively valued operators with traces, i.e. sums of diagonal elements equal to 1). This however implies i.e. the eigenvalues in question form indeed probabilities of a random variable (also real numbers, limited from 0 to 1, and altogether summing to 1). Therefore the density matrix of a pure state is a projection operator to this state (i.e. a pure state in probability equal to 1) and of a mixed state density matrix becomes a probabilitic mixture of pure states (represented by projection operators to those states each with a certain corresponding probability). This probability mixture can be therefore treated as a random variable and thus enable definition of the von Neumann entropy, exactly as the Shannon entropy but based on the probabilities present in the mixed state. In this manner the von Neumann entropy measures the extent of how much the state can be mixed, but on the other hand as well, the level of entanglement—if the 2 qubits system is in the Bell state e.g.

$$\frac{1}{\sqrt{2}} ( \vert 00 〉 + \vert 11 〉 ) ,$$

it resolves to both qubits being in maximally mixed states (maximally entangled state of the whole system), with the probabilities equal to exactly ½ for the mixed states qubits to reside in pure |0 [symbol] and |1 [symbol] . Now if the measurement of e.g. first qubit is made in the assumed as the reference basis {|0 [symbol] , |1 [symbol] } then assuming the complex state of 2 qubits was really in a perfect Bell state, the result will be truly random with a classical bit unveiled from the first qubit to be either 0 or 1 with exactly ½ probability and then the second qubit being instantly (non-locally, i.e. clearly violating limitation of interaction propagation at most with velocity of light despite possible spatial separation of those 2 entangled qubits, while preserving the realism supposition, meaning that the measurement only unveils the physical states properties) determined in a correlated state in this configuration (i.e. projected to a classical information). The statistics of these correlations can be measured and are already proven experimentally [1, 2] (after highly important theoretical debate starting from Einstein's Podolsky's and Rosen's objections in the 1935 [3] formulated as the famour EPR paradox) to violate classical limits imposed on such correlations (Bell inequalities [4, 5]).

Therefore discussing of entanglement as a fundamental aspect of truly non-deterministic QRNGs is believed to be important by the authors of the invention and in this context the novel proposed entangled QRNG protocol on correlated and anticorrelated Bell states is justified, because the entanglement by itself seems to be a basis for proper definition of quantum Information, which in that view consists rather of non-classical, non-local correlations (violating the classical Bell inequalities in statistics and also possessing the negative conditional entropy [6], alternatively formulated as the concept of partial Information [7] only present for quantum information, measuring the amount of classical information to be communicated in extent in the super-dense coding protocol [8], with the maximum limit for the Bell state entanglement equal to 1 additional bit of extent information on 1 bit communicated on each 1 qubit (encoding of 2 bits on 1 qubit by local operations under assumption that it is entangled with another qubit, later measured with upon in Bell basis).

The entanglement main characteristic is that it is a fundamentally non-local physical phenomenon. Therefore it is qualitatively different resource against problem of decoherence than local pure state of e.g. a qubit, because decoherence due to physical Interaction is of a fundamentally local character [9, 10]. Within the problematics of how to combat the decoherence, beyond the standard Shor's concept based quantum error correction codes [11], the advanced multi-particle entangled states are one of the possible options [12] for decoherence resilience, and it is evident if one considers e.g. a generalization of the 3-qubits W entanglement state:

$$\frac{1}{\sqrt{n}} ( \vert 10 … 0 〉 + \vert 01 … 0 〉 + \vert 00 … 1 〉 )$$

(only one state |1 [symbol] in the non-separable n-qubits tensor product). In such a case local decoherence of any one of entangled n qubits will not cause any significant deviation for state of the whole system, and in particular to the degree of mixedness of any other individual qubit (the decohered qubit in the worst case of the complete decoherence will simply disentangle from the whole W state entangled ensemble, leaving the n−1 qubits state in the following not much deviated from the original configuration, especially when n is large:

$$\frac{1}{\sqrt{n - 1}} ( \vert 10 … 0 〉 + \vert 01 … 0 〉 + \vert 00 … 1 〉 )$$

(again symmetric configuration of only one state |1 [symbol] in the non-separable now n−1 qubits tensor product). Due general concept of non-locality versus local decoherence [13], recently there has been a lot of interest towards considering quantum information within the topological degrees of freedom [14-16], what Is naturally concerning consideration of the topological character of quantum entanglement and thus emphasize the role of presented invention.

### BACKGROUND ART

As mentioned above the essential character of quantum entanglement, a purely quantum concept, can be described as a non-local or thus global phenomenon. Discussion of non-locality of quantum entanglement has been very active since formulation of the EPR programme in 1935 [3, 17]. Since then it became clear in the sixties, that quantum entanglement correlations in measurements violate classical limits imposed by statistical consideration [4]. There have long been discussed so called hidden-variables theories to complement for the seemingly missing elements of reality lacking in quantum mechanics description. But the Bell inequalities violation as well as the empirical confirmation by Aspect experiment [18], have ruled out the possibilities to address hypothetical variables as local. This resolves now to common understanding that quantum entanglement is essentially non-local if one is to sustain the realism assumption in science. As the property of non-locality lies in the center of interest of topology, it can be justified to search for some mathematical objects which can model the entanglement from the topological point of view. Such ideas were developed within last years, for example in Refs [19-21], as well as in recent conjectures based on the concept of entanglement being equivalent to curved space-time features of Einstein-Rosen Bridge [22, 23]. In this work we aim to present some special aspects of quantum entanglement in a topological interpretation and discuss possible applications towards quantum random number generator (QRNG) [24].

On a very abstract level the most intuitive model of the entanglement between two quantum states (for simplicity we limit our consideration to most simple two-dimensional quantum states, which are referred to as qubits) seems to be the entanglement of two geometrical rings. Topological character of such rings resembles entanglement between two qubits-despite the space separation the quantum entanglement remains intact same as the entanglement of two rings regardless of their sizes. It should be noted, that links of fundamental aspects of quantum mechanics with topological description and in particular braid groups, are all well-known concepts, leading from the most obvious example to geometrical explanation of quantum statistics (distinction of fermions and bosons in 3D) by topological differences in trajectories for elementary particles quantum states replacements, as well as concept of anyons [25] in 2D physical systems and discussion of QHE (Quantum Hall Effect), where the invention authors have formulated own contributions [26-28].

In terms of the braid group for 2D plane [29] the elementary entanglement would be represented by a 2-braid of form σᵢ², cf. FIG. 1 b)—two hooked rings. On the other hand, two unentangled qubits state would be represented by a trivial 2-braid, ε-two unentangled rings, cf. FIG. 1 a). However, such analogy is only able to describe the sole existence of the entanglement (hooked/entangled or unhooked/unentangled rings), while not the peculiarities of the modelled entanglement (e.g. differences between maximally entangled states in the Bell basis or the differences in a degree of entanglement between two qubits, such as

$$\frac{1}{\sqrt{2}} ( \vert 00 〉 + \vert 11 〉 )$$

$$and$$

$$\frac{1}{\sqrt{3}} ( \vert 00 〉 + \vert 01 〉 + \vert 01 〉 + \vert 10 〉 ) ) .$$

Nevertheless, the topological braid group model no ice some fundamental of entanglement types by their topological inequivalence when considering the entanglement of systems with 3 or more qubits. In a case of a 3-qubit system one can distinguish two topologically inequivalent entanglement types—the one corresponding to an entangled state, in which when any of 3 (or generally n) qubits is measured then 2 (or n−1) other qubits instantly become unentangled due to von Neumann projection and the algebraic structure of the quantum states tensor product linear combination (the Greenberger-Horne-Zeilinger GHZ state [30]), as well as the other type (a more W like state [31]) corresponding to such an entangled state of 3 (n) qubits configuration, in which after measuring of any of the 3 (n) qubits, the 2 (or n−1) others remain still entangled (in some Bell state selected arbitrarily, but correspondingly to the first qubit measurement outcome).

In case of the GHZ state,

$$\frac{1}{\sqrt{2}} ( \vert 000 〉 + \vert 111 〉 ) ,$$

or similar states, one can describe their topology (using the entangled rings model) in the form of the so called Borromean rings [32]. It is such rings arrangement that when cut open any of the rings the two remaining would always be unentangled.

In the braid group language such topology would correspond to 3-braid in form of σ₁·σ₂⁻¹·σ₁·σ₂⁻¹·σ₁·σ₂⁻¹, cf. FIG. 1 c).

A second (topologically inequivalent) type of entangled state of 3 qubits, is for e.g.

$$\frac{1}{2} ( \vert 000 〉 + \vert 011 〉 + \vert 101 〉 + \vert 110 〉 ) ,$$

which in terms of entangled rings corresponds to a topology of closed 3-linked chain-after cutting open any of the chain loops the two remaining will still be entangled.

In the braid group language such a topology would correspond to 3-braid in form of σ₁·σ₂·σ₁·σ₂·σ₁·σ₂, cf. FIG. 1 d).

This topological inequivalence of above entanglement types, very evident in geometrical representation, is on the other hand not easily visible in the entanglement tensor product representation algebraic structure or within the entanglement generation process, which can be described formally for instance in the language of single and two qubits quantum gates (linear unitary operators in corresponding Hilbert spaces), as presented below.

Basic quantum circuits generating different entanglement types described above are depicted in FIG. 2. Basic evaluations of those quantum circuits are presented below for clarity:
FIG. 2 a)—the Bell states generator-gapped regions evaluation:
   1. Initial state: |0 [symbol] ⊗|0 [symbol]
   2. After the Hadamard gate acting on qubit 1:

$$\frac{1}{\sqrt{2}} ( \vert 0 〉 + \vert 1 〉 ) ⊗ \vert 0 〉 = \frac{1}{\sqrt{2}} ( \vert 00 〉 + \vert 10 〉 )$$

3. After the CNOT gate acting on qubits 1 and 2:

$$\frac{1}{\sqrt{2}} ( \vert 00 〉 + \vert 11 〉 )$$

FIG. 2 b)—the Borromean rings topology state generator (GHZ 3-qubit entanglement)—gapped regions evaluation:
   1. Initial state: |0 [symbol] ⊗|0 [symbol] ⊗|0 [symbol]
   2. After the Hadamard gate acting on qubit 1

$$\frac{1}{\sqrt{2}} ( \vert 0 〉 + \vert 1 〉 ) ⊗ \vert 0 〉 ⊗ \vert 0 〉 = \frac{1}{\sqrt{2}} ( \vert 00 〉 + \vert 10 〉 ) ⊗ \vert 0 〉$$

3. After the CNOT gate acting on qubits 1 and 2:

$$\frac{1}{\sqrt{2}} ( \vert 00 〉 + \vert 11 〉 ) ⊗ \vert 0 〉 = \frac{1}{\sqrt{2}} ( \vert 000 〉 + \vert 110 〉 )$$

4. After the CNOT gate acting on qubits 2 and 3:

$$\frac{1}{\sqrt{2}} ( \vert 000 〉 + \vert 111 〉 )$$

FIG. 2 c)—the closed 3-linked chain topology state generator—gapped regions evaluation:
   1. Initial state: |0 [symbol] ⊗|0 [symbol] ⊗|0 [symbol]
   2. After the Hadamard gate acting on qubit 1:

$$\frac{1}{\sqrt{2}} ( \vert 0 〉 + \vert 1 〉 ) ⊗ \vert 0 〉 ⊗ \vert 0 〉 = \frac{1}{\sqrt{2}} ( \vert 00 〉 + \vert 10 〉 ⊗ \vert 0 〉$$

3. After the CNOT gate on qubits 1 and 2:

$$\frac{1}{\sqrt{2}} ( \vert 00 〉 + \vert 11 〉 ) ⊗ \vert 0 〉$$

4. After the Hadamard gate acting on qubit 3:

$$\frac{1}{\sqrt{2}} ( \vert 00 〉 + \vert 11 〉 ) ⊗ \frac{1}{\sqrt{2}} \vert 0 〉 + \vert 1 〉 = \frac{1}{2} ( \vert 000 〉 + \vert 001 〉 + \vert 110 〉 + \vert 111 〉 )$$

5. After the CNOT gate acting on qubits 3 and 2:

$$\frac{1}{2} ( \vert 000 〉 + \vert 011 〉 + \vert 110 〉 + \vert 101 〉 )$$

### SUMMARY OF INVENTION

The proposed Entanglement Quantum Random Number Generator (Entanglement QRNG) uses a special topological configuration of multi-qubits entanglement of quantum states to produce quantum randomness with the public certification.

The invention describes both the protocol and its generic implementing device, involving the specific 3-qubits quantum entanglement of generalized Bell state type (topologically inequivalent to different types of entanglements and easily generalized to multiple-qubits as shown in the invention description), characterized also in the topological terms, that enables private quantum random number generation with a publicly accessible proof of randomness, thus allowing an external party to freely and publicly verify the randomness of the generated sequence without disclosing of its secrecy or distorting it in any way (this feature of QRNG is proposed for the first time and has an important role for applications in both quantum and classical cryptography). The invention of the Entanglement Quantum Random Number Generator with public verification of randomness is based upon the originally proposed entanglement based random correlation generator, assuring that generated random sequences are randomly correlated and anti-correlated on corresponding positions: in the most basic configuration of the device its main feature is publicly verified absolute randomness not sacrificing it's secrecy, possible due to a secret correlation—anticorrelation relation on subsequent bits positions of both random bit sequences (one kept secret, and the other one revealed). Thus described invention offers for the first time a technical solution to provide a publicly accessible proof of privately and secretly generated randomness without compromising its privacy and secrecy, thus allowing an external party to freely and publicly verify the randomness of the generated sequence without disclosing of its secrecy or distorting it in any way. The new important properties of the proposed invention find applications in many areas of technology and science where randomness is needed. These unique properties are strongly linked with multiple qubits entangled states and their topological features, which thus finds important applicability in the industry of information and communication security. The invention uses non-trivial quantum entanglement configuration in industrial applications harnessing its non-classical and non-local power, which leads to identification of not achieved previously practical features. The main advantage in contrast to standard QRNG protocol is that all previously considered schemes did not offer any mean of public verification of true randomness keeping secrecy of the generated random number. This is very critical issue in terms of applications as potential users of QRNGs must rely on trust assumption, not being able to offer verification of the very randomness used without revealing it. The proposed invention and its generic implementing device (shown in the FIG. 3 with workflow diagram depicted in the FIG. 4) solve this issue by enabling objective verification of the true randomness of the bit sequence, without compromising its secrecy. Generalized extension of the invented device of Entanglement QRNG (as presented in FIG. 5 and FIG. 6, with four or more entangled qubits) uses shorter sequences of random bits verified statistically to be truly random in order to information theoretically certify same randomness of longer sequences of bits remaining secret (this result has not been achieved before in the field of randomness generation and is of a fundamental significance for the described invention).

### Technical Problem

The technical problem which is considered upon the presented invention consists of:
1. provision of the truly random (upon quantum non-determinism) process as a basis for generation of random numbers (random bit sequences);
2. provision of means to certify this true randomness, that is not compromising its secrecy.

### Solution to Problem

Differences mentioned in the Background Art section between two mentioned types of three qubit entanglement states, characterized in topological terms with 3-link chain or Borromean rings topology, can be used to discuss distinct basic protocols in area of the quantum random number generators QRNG) based on quantum entanglement.

Let us remind the form of the Bell basis:

$${Ψ}_{AB}^{+} = \frac{{{\vert 00 〉}_{AB} + \vert 11 〉}_{AB}}{\sqrt{2}} = , {Ψ}_{AB}^{-} = \frac{{{\vert 00 〉}_{AB} - \vert 11 〉}_{AB}}{\sqrt{2}} , \\ {Φ}_{AB}^{+} = \frac{{{\vert 01 〉}_{AB} + \vert 10 〉}_{AB}}{\sqrt{2}} , {Φ}_{AB}^{-} = \frac{{{\vert 01 〉}_{AB} - \vert 10 〉}_{AB}}{\sqrt{2}} . \qquad ( 1 )$$

In a sense of quantum measurement, interpreted accordingly to probabilities represented by modulus squared of quantum superposition coefficient standing with the quantum state corresponding to measurement result and von Neumann projection postulate, those state can be grouped in two classes: the correlated and anti-correlated ones. States Ψ⁺_{AB} and Ψ⁻_{AB} are correlated in a specific way in sense of results of measurements of both qubits—if the first qubit is found in state |0 [symbol] _{A} then second qubit must be also in state |0 [symbol] _{B}, and similarly for state |1 [symbol] —this can be called type 1 of the entanglement (correlation of the measured states results). States Φ⁺_{AB} and Φ⁻_{AB} are in contrast correlated in a deferent manner—the result of the second measurement is always opposite to the result of the first measurement-type 2 of the entanglement (anti-correlation of the measured states results).

As to determine which type of correlation one deals with at the entangles state of 2 qubits, one must measure both qubits to get the classical information (measurement outcome) to identify the type of the correlation.

Lets consider those two distinct types of correlation within the Bell basis (correlation and anti-correlation) as a random results of the measurement of entangled 3-qubit state, characterized by a specific topological nature of its entanglement. This fundamental difference (correlation or anti-correlation) will be used to encode classical random bit in the sequence generated within such an entanglement based Quantum Random Number Generator protocol.

An example of such a 3-qubit state has the form

$${{{{\frac{1}{2} ( \vert 000 〉}_{XAB} + \vert 011 〉}_{XAB} + \vert 101 〉}_{XAB} + \vert 110 〉}_{XAB} ) .$$

In terms of topological description of entanglement as a topology of rings, this state is represented by a closed 3-linked chain (each chain is linked with both others). In such a chain entanglement configuration it is possible to cut one of the rings of chain and remove it without cutting two remaining chain rings—those two rings will remain entangled. In the notion of above quantum state the cutting procedure can be identified with the measurement of one of 3 qubits in the computational basis (i.e. von Neumann projection of quantum information of this one qubit to classical bit information of either 0 or 1). But the process of cutting one of the chain rings can be carried out in two distinct ways, which correspond to two distinct results of measurement of one of the qubits rendering the measurement outcome to be 0 or 1. Different measurement results corresponds to qualitatively different joint entangled state of the two left qubits.

According to the above 3-qubits entangled state one can write

$${{{{\frac{1}{2} ( \vert 000 〉}_{XAB} + \vert 011 〉}_{XAB} + \vert 101 〉}_{XAB} + \vert 110 〉}_{XAB} ) = \qquad ( 2 )$$

$${{{{{{\frac{1}{\sqrt{2}} \vert 0 〉}_{X} \frac{1}{\sqrt{2}} ( \vert 00 〉}_{AB} + \vert 11 〉}_{AB} ) + \frac{1}{\sqrt{2}} \vert 1 〉}_{X} \frac{1}{\sqrt{2}} ( \vert 01 〉}_{AB} + \vert 10 〉}_{AB} ) ,$$

where the LHS of the equation is represented upon the Hilbert space in form H_{X} ⊗H_{A} ⊗H_{B} and the RHS in form H_{X} ⊗(H_{A} ⊗H_{B}).

The measurement of X qubit will lead to one of the two possible results with the same probability ½. The resultant state |0 [symbol] _{X} corresponds to the state

$${{\frac{1}{\sqrt{2}} ( \vert 00 〉}_{AB} + \vert 11 〉}_{AB} )$$

and the resultant state |1 [symbol] _{X} corresponds to the state

$${{\frac{1}{\sqrt{2}} ( \vert 01 〉}_{A B} + \vert 10 〉}_{A B} ) .$$

The above scheme can be represented in form of a quantum circuit, cf. FIG. 3.

Such a setup can entanglement based random correlation generator. By continuously initiating the setup with state |00 [symbol] _{X AB} and performing the measurement on auxiliary qubit X (or in fact on any other qubit) the setup will generate as an outcome, in a truly (non-deterministically quantum) random manner, the 2-qubit entanglement state in a specific correlation type, either fully correlated or fully anti-correlated (entanglement of qubit A and B if qubit X was measured).

As the main our invention we present now Entanglement Quantum Random Number Generator (Entanglement QRNG) with publicly verifiable randomness that is an extension of the above presented original concept in the field of QRNG.

It is a simple protocol representing a generic device based on any physical quantum entanglement implementation, involving specific 3-qubit quantum entanglement characterized in topological terms, for quantum random number generation with publicly accessible proof of randomness, which is conceptually achieved on a fundamental (fraud-resistant) level for the first time.

As quantum random number generators are gaining in popularity, especially with regard to possibility of a break-through with the efforts in construction of a scalable quantum computer that could endanger deterministic pseudo-randomness based on computational complexity, a protocol allowing for an external party to freely and fraud-proofly verifying of the true randomness of the generated sequence without distorting it in any way and most importantly without getting to know this very sequence by a party which is only interested in checking if the random sequence is truly random, seems to be of a potential use. In other words this protocol for the first time offers the generation of the random sequence with means to publicly prove the true randomness of the generated sequence without revealing this sequence, which would render it useless in different cryptographic applications. It should be noted that the previously considered QRNG protocols do not offer such mean of public verification of true randomness, and the randomness using party must rely on trust to the QRNG device supplier. The QRNG device based on the here proposed protocol is on the other hand publicly and objectively verifiable true randomness generator. It is worth to note that the public and objective verification of true randomness concerns in this protocol the very sequence of random bits that undergo desired randomness application, and thus when verified by any external party that these bits are truly random they are guaranteed to be so within a corresponding application without the need to reveal their values. This is in contrast to possible claims for other means of random bit sequences randomness verification, when for example random positions of the sequence are unveiled and their randomness publicly tested: in that case if the verification is positive it only guarantees to external parties that these very tested bits were random, but does not give any guarantee about the randomness of the remaining bits if one is not able to prove publicly the true randomness of the testing bits choice. In short the novelly proposed here QRNG protocol gives mean for universal randomness proof based on the fundamental correlation/anti-correlation of quantum entangled states distributed between protocol parties. In order to prevent attacks on the protocol based on the decreased measures of entanglement between the distributed qubits states (in essence with external eavesdropping qubits being co-entangled, thus taking the 3 or in general n qubit states out of their maximal and symmetrical entangled configurations) this QRNG protocol could be supplemented in the initial stage with well-known protocols of entanglement distillation and purification [33-35]).

One can consider the following formalization of the protocol, which we will call a quantum random number generator with public proof of randomness:
1. Let's assume that Alice owns generator described above.
2. Alice continuously initiate quantum setup from FIG. 3 with state |000 [symbol] _{ABC}.
3. After each initialization Alice performs a quantum measurement on qubit A, and keeps the result of each measurement in secret (this will be called a sequence Aᵢ). Only Alice has the knowledge what type of entanglement was randomly chosen for each generated pair.
4. In result a continuous series of entangled pairs of B and C qubits are produced, with entanglement defined by elements of the sequence Aᵢ (cf. FIG. 5, as follows

$$0 \to \frac{{{\vert 00 〉}_{B C} + \vert 11 〉}_{B C}}{\sqrt{2} ,} - correlated state , \\ 1 \to \frac{{{\vert 01 〉}_{B C} + \vert 10 〉}_{B C}}{\sqrt{2}} - anticorrelated state .$$

5. Next Alice performs a measurement on qubits in each pair, which results in two bit sequences:
   Bᵢ—sequence of random bits resulting from measurements of qubit B from each pair,
   Cᵢ—sequence of random bits resulting from measurements of qubit C from each pair (in fact there is no need to perform qubit C measurements as the sequence Bᵢ and the sequence Aᵢ define their states unequivocally).
6. Alice ends with 3 equal length sequences:
   sequence of entanglement type selected for each pair, Aᵢ,
   Bᵢ and Cᵢ—mutually correlated, by the sequence Aᵢ, random sequences.

For someone who does not have any knowledge about the types of entanglement selected for each pair, sequences Bᵢ and Cᵢ are completely random and a prediction of the bits from one sequence (e.g. Cᵢ) basing only on the second (Bi) sequence is in such case impossible. On the other hand, for Alice, from all those three sequences (Bᵢ, Cᵢ, and entanglement type selections sequence Aᵢ) only two (and any arbitrary two) presents a random information.

But the most important thing is that any two sequences, e.g. Bᵢ and Cᵢ must have identical statistical properties (due to entanglement correlation or anticorrelation), and this feature is crucial in the proposed invention allowing Alice for the enhanced randomness verification.

### Advantageous Effects of Invention

As there is always a doubt whether the generated sequence is truly random or not, both in classical and quantum case (in the classical case this doubt can be addressed to the problem of the definition of the randomness itself, and in the quantum case it corresponds to the quantum mechanics interpretation differences between the von Neumann measurement concept based on an objective frequential probability and Fuchs Quantum Bayesianism theory, so called QBism, based on a rather subjective conditional probability [36, 37], for example discussed in Ref. [38]), statistical randomness testing offers some kind of verification. But the randomness testing suffers from a fundamental problem—lack of universal set of tests. In fact, there is an infinite number of different pattern matching tests, as there is an infinite number of patterns.

Therefore comprehensive testing can be highly resource consuming, and in general not available to be implemented in miniaturized quantum random number generator solutions. On the other hand a good quality randomness for a personal cryptographic usage (initial secrets, initialization vectors, nonces, etc.) is highly desirable. The proposed protocol can be used to transfer the weight of randomness testing from the generator device or the user to some external public party (which can have unlimited computational resources in comparison to a single user/generator).

In view of the above further steps of proposed protocol can realize the following use case scenario:
7. Alice doubting the randomness of the Bᵢ sequence publicly sends the Cᵢ sequence to the Verification Center (VC).
8. VC publicly performs a series of resource consuming randomness testing, deciding whether the sequence Cᵢ can be considered truly random or not.
9. VC publicly informs Alice about its decision.
10. In case of a positive decision Alice gains the certainty that the sequence B remaining secret is also truly random.

In this protocol Alice can perform own initial randomness testing and use VC to enhance testing procedure. Due to the specific way of generation of sequences Bᵢ and Cᵢ, a public announcement of one of them does not affect the secrecy of the other one. The public character of VC randomness testing procedure serves as a warranty against fraud—decision of VC can be verified by any other public party (in general Alice can use multiple VCs simultaneously to increase the precision of the decision).

It is worth mentioning that VC can be possibly equipped with the quantum computer, which could be used to check whether the generation process is truly random or biased (for example, by the presence of a classical and thus deterministic influence on the generation process).

Proposed protocol offers randomness certified by classical statistical tests performed publicly. Here the quantum randomness has a twin origin—quantum measurement choosing correlated or anticorrelated entangled state of a qubits pair, and measurement unentangling this pair. Alice, randomly performing verification of entanglement existence, tries to check whether the quantum source of entropy is of good quality or not. In this context it can be considered as a member of a wide class of so called Device Independent RNG [39, 40], which are also verified statistically, as their generation process can be considered biased. In the proposed case, considered quantum randomness is based on a quantum measurement, but the bias can correspond here not only to implementations imperfections, as considered for the Device Independent RNG concept [39, 40], but also to a non-trivial problem with introducing subjectivism to the quantum measurement due to questioning the correctness of using the frequentist probability in von Neumann measurement concept instead of conditional probability as described within the Quantum Bayesianism theory [36, 37]. As the quantum measurement in its foundations is unrepeatable and destructive and No-Cloning theorem [41] applies, the concept to describe a measurement with a frequentist probability is somehow problematic. But regardless of the nature of the bias (either fundamental or implementation-wise), the proposed protocol allows to perform inaccessible in a standard case, due to computational inefficiency, simultaneously (with use of multiple VCs) randomness tests on large blocks of data (instead of rather short blocks in standard tests, for example NIST test suite [42]).

The problem of analyzing the entropy of the source of randomness is surely crucial for Imperfect physical applications of quantum random generators (e.g. [40, 43]). Some approaches are limited to specific generating techniques and setups [40, 44, 45]. More universal approaches are concepts of Device Independent RNG [39, 46], where some of the protocols extract quantum randomness and discard deterministic behavior [47, 48] due to quantum processes implementation shortcomings. Self-testing QRNG protocols are also considered as part of device independent approach, for example in Ref. [49], where testing of the dimension of uncharacterized classical and quantum systems allows the observer to separate the quantum part of the randomness from a deterministic classical part, which results with very high confidence of 99

### 1. GHZ-Type States for Quantum Randomness

As mentioned previously, the GreenbergerHorneZeilinger (GHZ) [30] state Is a specific type of a 3-qubit entangled state. It has a following form

$${{\vert G H Z 〉 = \frac{1}{\sqrt{2}} ( \vert 000 〉}_{A B C} + \vert 111 〉}_{A B C} ) . \qquad ( 3 )$$

It is worth noting that if both discussed states,

$$\vert GHZ ) = \frac{1}{\sqrt{2}} ( \vert 000 〉 + \vert 111 〉 ) and \vert 3 ‐ link chain 〉 = \frac{1}{2} ( \vert 000 ) + \vert 011 〉 + \vert 101 〉 + \vert 110 〉 ) ,$$

were similarly used, as in discussed above protocol, the results, from point of view of the entropy, are quite different. If one of qubits in the series of GHZ states was measured in a computational base, then each time both other qubits are simultaneously unentangled in pure states and their measurements carry no entropy (the only entropy is within the first unentangling measurement). In the case of a series of 3-link chain states, to determine the classical states of each 3 entangled qubits, one needs to perform not one but two quantum unentangling measurements, what leads to twice as big entropy as in GHZ case. If one considers on the other hand the W state, defined as follows

$$\vert W 〉 = \frac{1}{\sqrt{3}} ( \vert 100 〉 + \vert 010 ) + \vert 001 〉 ) ,$$

then in case of a series of measurements made on each first qubit in series of W states will lead to two different results, either all 3 qubit states are defined—first qubit is in state 1, or only the first qubit is defined in state 0 and the two other qubits stays in anticorrelated entangled state—in this case another unentangling measurement is needed to define classical state of all three qubits. Of course due to the above situation all 3 bit sequences will have non-uniform distributions of 0s and 1s (which is a consequence of the lack of binary symmetry in entanglement configuration of the W state). In terms of entropy, the series of measurements of qubits triples entangled in W states leads to entropy smaller than in GHZ states.

Generalized multiple GHZ state can be written as

$${{{\vert G H Z 〉}^{( M 〉} = \frac{1}{\sqrt{2}} ( \vert 0 〉}^{{⊗}^{M}} + \vert 1 〉}^{{⊗}^{M}} ) , \qquad ( 4 )$$

where M>2 is the number of qubits, and |α [symbol] ^{⊗}^{^{M}} is a M-times tensor product of states |0

[symbol]

One can say that GHZ-type states are a multiple qubits generalization base structure of one of the Bell basis states of qubits entangled pair, the

$${{Ψ}_{A B}^{+} = \frac{1}{\sqrt{2}} {( \vert 00 )}_{A B} + \vert 11 〉}_{A B} ) .$$

In all of those states after the measurement each qubit is in the same state as all others. This property enables to consider another important feature for QRNG, namely the simultaneous generation of a random number string in all parties holding qubits which state were described by a GHZ-type state, which is referred as quantum secret sharing [46, 50]. Such concept holds potentially important aspect for cryptography of secret communication, introducing extended concept of the Quantum Key Distribution (QKD) protocol (where all engaged in distribution parties trust an entanglement source), not hampered by point-to-point topology, which is often considered one of main drawbacks of quantum cryptography. The considered in detail multiparty QRNG protocol can be for example utilized to distribute securely (in terms of theoretical security guaranteed by quantum mechanics laws) a classical and fully random key (a random bit sequence) between multiple parties simultaneously, thus enabling symmetrically encoded secure broadcasting, or any other random numbers application which require the sequence to remain known only to engaged parties.

In case of the simplest scenario the GHZ entangled 3-qubit state can be considered with qubits A, B, C. After the first measurement of any of the qubits all of the 3 qubits will attain certain state depending on this measurement result due to the von Neumann projection postulate and GHZ state algebraical tensor product structure. Assuming continuous generation and distribution of the GHZ states, such procedure, if repeated consecutively, will generate 3 copies of a random sequence of classical information bits.

But in the case when one of the party will measure a single qubit which is in one of the below states, truly randomly selected,

$${{{{{{{{\frac{1}{\sqrt{2}} ( \vert 000 〉}_{A B C} + \vert 111 〉}_{A B C} ) , \\ \frac{1}{\sqrt{2}} ( \vert 001 〉}_{A B C} + \vert 110 〉}_{A B C} ) , \\ \frac{1}{\sqrt{2}} ( \vert 010 〉}_{A B C} + \vert 101 〉}_{A B C} ) , \\ \frac{1}{\sqrt{2}} ( \vert 011 〉}_{A B C} + \vert 100 〉}_{A B C} ) , \qquad ( 5 )$$

the results of measurements of other two qubits (of qubit B and C) will be totally independent from each other and from result of qubit A measurement.

The above states can be selected in a random manner by using of another two additional qubits, as follows.

5-qubits system can be organized to generate a random state from above set after being initialized by state |00000 [symbol] _{XY ABC}, where qubits X and Y are auxiliary qubits. The quantum circuit setup state before the measurement of any of two auxiliary qubits states should be in the state

$${{{{ψ}_{X Y A B C} = \frac{1}{2} \vert 00 〉}_{X Y} \frac{1}{\sqrt{2}} ( \vert 000 〉}_{A B C} + \vert 111 〉}_{A B C} ) + {{{\frac{1}{2} \vert 01 〉}_{X Y} \frac{1}{\sqrt{2}} ( \vert 001 〉}_{A B C} + \vert 110 〉}_{A B C} ) + {\frac{1}{2} \vert 10 〉}_{X Y} \frac{1}{\sqrt{2}} {( \vert 010 )}_{A B C} + {\vert 101 〉}_{A B C} ) + {{{\frac{1}{2} \vert 11 〉}_{X Y} \frac{1}{\sqrt{2}} ( \vert 011 〉}_{A B C} + \vert 100 〉}_{A B C} ) . \qquad ( 6 )$$

According to above state ψ_{XY ABC} after the measurements of qubits X and Y, the overall state of qubits A, B and C is defined, but in an entirely random manner, same as the two mentioned measurements results.

After the measurement of any single qubit of these three qubits, the states of the other two qubits will, in a random manner attain their respective values depending on the type of the entanglement.

Public announcement of one of the random sequences will not affect the security of random sequences.

Now Alice can verify the randomness of all sequences just by public announcement of one of them to the Verification Center (VC). All other, kept in secret, random sequences share the same statistical correlation as the one published and verified. In came of a positive assessment of the VC, the protocol leads to an interesting result—Alice certified twice the long random sequence as the sequence being tested for randomness.

This is an example of a generalization of the discussed above scheme for quantum random number generator with public proof of randomness. Only one sequence is required to be publicly exposed to be checked for randomness thus verifying the randomness of the other sequences, while all other sequences (in case of 3-qubit scheme only one sequence, in 5-qubit scheme 2 sequences, etc.) have the same statistical properties but their actual values stay undisclosed.

A quantum circuit scheme is depicted in FIG. 5. To achieve random selection of qubits A, B and C entangled state the 2 measurement gates are introduced, which control the single-qubit gates (measurement gates controlling other unitary quantum gates in quantum information circuit is a well-known approach, e.g. present in the circuit of the quantum teleportation [51]).

Similar setup can be proposed for higher number of entangled qubits. For clarity with the 4-qubits entangled state one will have

$${{{{{ψ}_{XYZABCD} = \frac{1}{2} \vert 000 〉}_{XYZ} \frac{1}{\sqrt{2}} ( \vert 0000 〉}_{ABCD} ) + \vert 1111 〉}_{ABCD} ) + \\ \frac{1}{2} \vert 001 {{〉}_{XYZ} \frac{1}{\sqrt{2}} {( \vert 0001 )}_{ABCD} + \vert 1110 〉}_{ABCD} ) + \\ {{{\frac{1}{2} \vert 010 〉}_{XYZ} \frac{1}{\sqrt{2}} ( \vert 0010 〉}_{ABCD} + \vert 1101 〉}_{ABCD} ) + \\ {{{\frac{1}{2} \vert 011 〉}_{XYZ} \frac{1}{\sqrt{2}} ( \vert 0011 〉}_{ABCD} + \vert 1100 〉}_{ABCD} ) + \\ \frac{1}{2} \vert 100 〉}_{XYZ} \frac{1}{\sqrt{2}} {{( \vert 0100 〉}_{ABCD} + \vert 1011 〉}_{ABCD} ) + \\ {{{\frac{1}{2} \vert 101 〉}_{XYZ} \frac{1}{\sqrt{2}} ( \vert 0101 〉}_{ABCD} + \vert 1010 〉}_{ABCD} ) + \\ {{{\frac{1}{2} \vert 110 〉}_{XYZ} \frac{1}{\sqrt{2}} ( \vert 0110 〉}_{ABCD} ) + \vert 1001 〉}_{ABCD} ) + \\ {{{\frac{1}{2} \vert 111 〉}_{XYZ} \frac{1}{\sqrt{2}} ( \vert 0111 〉}_{ABCD} + \vert 1000 〉}_{ABCD} ) , \qquad ( 7 )$$

where qubits X, Y and Z are auxiliary qubits for setting random state of 4 qubits A, B, C and D.

The measurement of 3 auxiliary qubits results in arrangement, in a truly random manner (guaranteed by the fundamentally non-deterministic quantum measurement property), of a specific type of the 4 qubits entanglement.

One can also consider different setup, this time consisting of four qubits, A, B, C and D, initiated in the following state:

$${{{Ψ}_{A B C D} = \frac{1}{2 \sqrt{2}} \vert 0 〉}_{A} ( \vert 000 〉}_{B C D} + {\vert 011 〉}_{B C D} + {{{{\vert 101 〉}_{B C D} + \vert 110 〉}_{B C D} ) + \frac{1}{2 \sqrt{2}} \vert 1 〉}_{A} ( \vert 111 〉}_{B C D} + {{{\vert 100 )}_{B C D} + \vert 010 〉}_{B C D} + \vert 001 〉}_{BCD} ) . \qquad ( 8 )$$

The measurement in this entangled four qubit state of the qubit A will lead to one of two possible 3-link chain states for qubits B, C and D. Next measurement on any of those three remaining qubits (for example qubit B) will choose appropriate entangled state for 2 remaining qubits, C and D. Final measurement of one of the C and D qubits set their states (all three measurements are considered in computational basis, similarly as all mentioned measurements in the invention description). Iterating of such procedure for series of states Ψ_{ABCD} will result in 4 sequences, where 3 are independent, similarly as in the beginning of this section.

Hereinafter we would like to shortly summarize different possible approaches to entangled QRNG protocols and outline some basic differences in such possible protocols regarding topological configurations of utilized entanglement (for 2-qubits entangled protocol the situation is trivial, however in 3-qubits protocols it becomes more complex with different possible scenarios for GHZ [30], generalized Bell states and W [31] entanglement types used for QRNG)—in order to highlight advantages of the proposed invention. Before we proceed to the protocols summary, one should remind that 3-qubit GHZ state if measured for 1 qubit projects all remaining qubits to disentangled pure states, the 3-qubits generalized Bell state if measured for 1 qubit projects the remaining 2 to maximally entangled 2-qubit Bell states—correlated or anticorrelated based on the 1st qubit measurement outcome, and finally the 3-qubits W state after measurement of 1 qubit projects the remaining 2 to either unentangled correlated (the same) pure states or alternative to maximally entangled Bell state (depending on the outcome of the first qubit measurement). One should also remark that the 3-qubits GHZ and generalized Bell states will behave similarly if one change the basis of the measurement to the maximally non-orthogonal basis (thus the GHZ state will behave like the generalized Bell state and conversingly).

The most simple case is the 2-qubits Bell state based QRNG. This basic protocol can be utilized towards proof of the true randomness but also generalized towards secret sharing (if Alice and Bob share entangled qubits), and be extended upon the generalized 3-qubits (or even n-qubits) Bell states, to make sure, that the choice whether the subsequent positions in coupled resulting bits strings are correlated or anticorrelated. The latter case of the extension of proposed entangled QRNG protocol towards secret sharing can be found linked to the original formulation of the GHZ based quantum secret sharing protocol, with the differences related to a problem of the basis changes necessity (while the GHZ state is measured without the basis change it then finds very convenient application towards multi-party topology in quantum key distribution). Finally there remains discussion of how would differ the entanglement based QRNG defined upon the 3-qubits W state along with the n-qubits generalization (the below analysis is to show that such an entanglement QRNG protocol based on the W state would fall substantially short of QRNG requirements and would not be suited for true randomness generation, illustrating that the symmetry of the generalized Bell states topologically different from the lack of W state symmetry plays a crucial role for QRNG). Let us then consider the following scenario: Alice, Bob and Charlie share each one a qubit from a 3-qubits W state:

$$\frac{1}{\sqrt{3}} ( \vert 100 〉 + \vert 010 〉 + \vert 001 〉 ) .$$

The first step would be for a measurement of her qubit: with probability ⅓ she will get her qubit projected to state |1 [symbol] , while the remaining qubits of Bob and Charlie will both collapse to states |0 [symbol] —anti-correlated with Alice's result—yet with probability ⅔ Alice will measure |0 [symbol] , thus projecting two remaining qubits of Bob and Charlie into fully mutually anticorrelated Bell state. The situation is thus the following, in each position of the classical bits sequences where Alice has 1's, Bob and Charlie will have 0's (note that Alice has 1's in ⅓ of the bits string positions, while the remaining ⅔ of the bits string is occupied by l's). This immediately points to non-uniform distribution of bits in the Alice's string due to lack of binary symmetry of the W state (the departure from the symmetry will only deepen with the increasing number of qubits, while it is clear that generalized n-qubits W states will recursively reduce to n−1 qubits W states upon subsequent measurements by the protocol parties). Similarly Bob and Charlie in their respective bits strings will have ⅓ of 0's (at the positions where Alice has 1's) as well as additional ⅓ of 0's and ⅓ of 1's (in n anticorrelated coupling between their both strings, after any of them first performs measurement on Bell states carried on qubits registers' positions where Alice projected her qubits to states of |0 [symbol] . Therefore Bob and Charlies bits sequences will of course effectively contain nonuniform distribution of ⅔ bits in values of 0's and ⅛ of 1's. Due to this analysis it is evident that W state based QRNG is not valid upon the lack of symmetry and thus requires to discarding certain part of generated outcome thus significantly lowering its efficiency.

### BRIEF DESCRIPTION OF DRAWINGS

FIG. 1 A simple topological model corresponding to inequivalence in terms of topology of the basic quantum entanglement types for two-dimensional quantum systems (qubits). As elements of the braid group are in fact closed loops, the gapped lines were added for clarity.

FIG. 2 Exemplary basic quantum circuits schemas depicting topologically inequivalent entanglement types generation. Gapped regions depicts consecutive steps of quantum circuit evaluation.

FIG. 3 Quantum gate scheme of a random correlation entanglement generator with 2-qubit entanglement state and one auxiliary qubits X. Without (a) or with (b, c) a random selection of 2-qubit entangled state type. Double line represents classical information about the measurement result.

FIG. 4 Schematic elements of protocol for quantum random number generator with public proof of randomness: a) generation of random correlations; b) correlation types; c) possible measurement outcomes.

FIG. 5 Quantum circuit scheme with gates of a random correlation entanglement generator with 3-qubit entanglement state and two auxiliary qubits X and Y. The generalization of the protocol (increased security of the multiple consent) is attained with the random selection of 3-qubits entangled state type, which is omitted in case (a) and included in cases (b, c). Double line represents classical information about the measurement result.

FIG. 6 Quantum gate scheme of a random correlation entanglement generator with 4-qubits entanglement state and three auxiliary qubits X, Y and Z. Without (a) and with (b, c) random selection of 4-qubits entangled state type. Double line represents classical information about the measurement result.

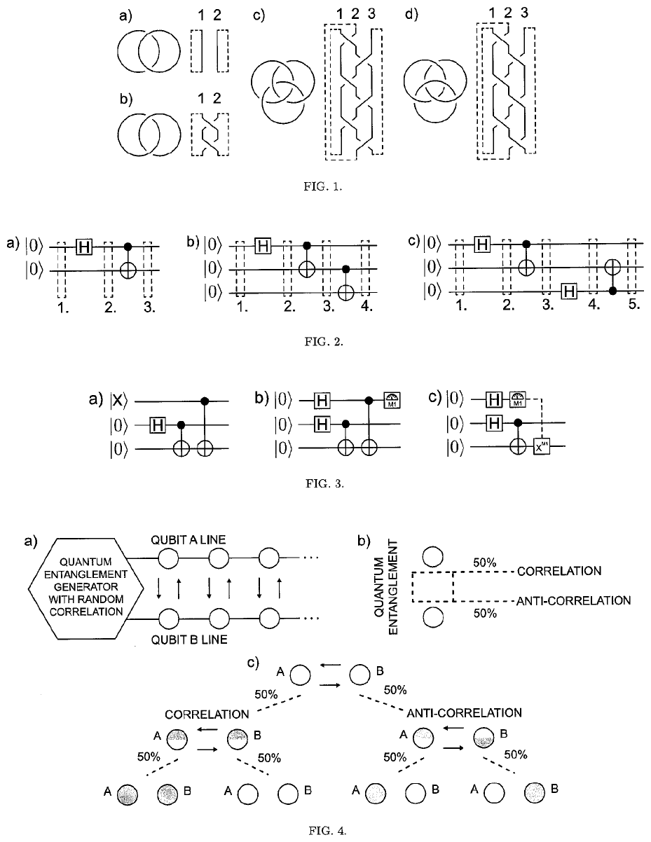

### DESCRIPTION OF EMBODIMENTS

Generally the QRNGs are currently considered to be in the stage of industry adoption technology level (there are commercial companies already selling production QRNG devices, which hold one key advantage over RNGs based on classical in contrast to quantum physical effects, i.e. fundamentally non-deterministic randomness, which is impossible to predict due to quantum mechanical laws, no matter what technology used).

The presented above invention for entanglement based quantum random number generator is based on multi-qubit entanglement properties. In 2016, an experimental setup for generation for the ten-photon polarization entanglement with use of BBO (beta-barium borate) crystals was presented, cf. Ref. [52], opening new area for the quantum engineering and potential extension of the proposed device implementation.

In view of the current development in quantum technologies, the requirements of presented schemes can already be technologically met and the herewithin proposed invention can be implemented technically with the use of qubits carriers and quantum circuits employing Hadamard and Quantum Controlled Negation (CNOT) logical gates along with the quantum measurement interfaces.

The basic device component of the proposed invention of Entanglement QRNG with public certification of randomness is the device implementing the originally proposed entanglement based random correlation generator. The implementation of this device (as a crucial component of the EQRNG) is presented upon its quantum circuits architecture in the FIG. 3.

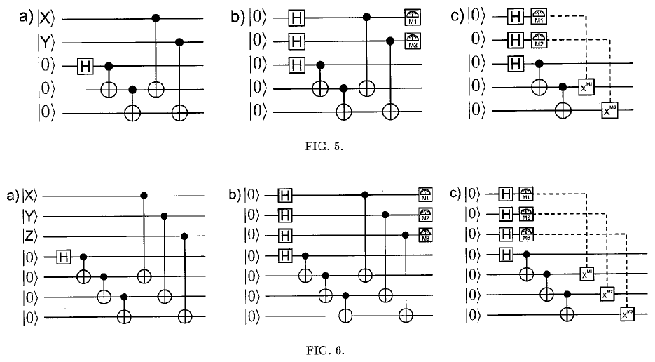

The generic device implementing the Entanglement QRNG with public randomness verification is built upon the quantum engineering components providing implementations of qubits and their control operations producing quantum entanglement. Those technologies are already matured and can be used as subcomponents of the system implementing the proposed invention accordingly with the presented its schematic architecture (cf. FIG. 5. for the extended device architecture presented in the quantum circuits specification).

The choice of particular implementation of given components upon realization of the quantum circuit architecture of the actual device are of less importance. The generic device can work on any regime of quantum information processing and control (with qubits implemented upon different degrees of freedom in physical systems of both light and matter). The recent progress is implementation of qubits and their control operations including the required Hadamard and CNOT gates (for introducing multi-qubits entanglements) is summarized in publications [53-67].

The measurement setups for each single qubit in the above schemes can be implemented with use of one polarization beam-splitters and two single-photon detectors and the quantum gates for polarization encoded qubits are also widely available and rapidly developed, with currently ongoing implementations of integrated gates (e.g. cf. Refs [68, 69]).

The discussed device is thus within the reach of practical implementation and its quantum circuit architecture is presented on the FIG. 3 (entanglement based random correlation generator), FIG. 5 (extended entanglement QRNG with public certification of randomness) and FIG. 6 (its generalized version).

The workflow of the device is presented on the diagram in the FIG. 4.

### INDUSTRIAL APPLICABILITY

The range of applications of random numbers is vast, especially in the domain of information and communication security, to answer such needs as assisting in providing secrecy, authenticity and integrity of information processing and communication. In this special domain of randomness utilization also the privacy of generated random number plays fundamental role for security related issues of information processing and communication.

On the plane of possible applications the proposed novel QRNG protocols, i.e. quantum random number generator with publicly verifiable randomness, with their discussed generalizations is thus of high significance for cryptography and secure communications (including also problems of authentication), as they introduce new important properties. The main advantage in contrast to standard QRNG protocol is that all previously considered schemes did not offer any mean of public verification of true randomness. This is very critical issue in terms of applications as potential users of QRNGs must rely on trust assumption, not being able to offer verification of the very randomness used without revealing it. The originally proposed here QRNG protocol and its generic implementing device will hence enable objective verification of the true randomness of the used bit sequence, without disposing of its secrecy.

The new important properties of the proposed Entanglement QRNG with certified proof of randomness invention described above find important applications in many areas of technology and science where randomness is needed. These unique properties are strongly linked with multiple qubits entangled states and their topological features, finding important applicability in the industry of information and communication security.

It could be added that the topology related nature of quantum entanglement is currently a hot topic of consideration relating the links between quantum mechanics and relativity, being revisited in the efforts of the Grand Unification of physical theories [70, 71]. Understanding of how quantum entanglement manifests its non-local peculiar properties, or as Einstein called it, the spooky action over a distance, violating (empirically verified [17, 18]) the local realism assumptions of classical physics, is certainly not yet achieved. But in terms of recent progress [72-77] topology (with links to direct topology of space-time) may be considered one of the most promising directions. In that regards employing the topological properties of non-trivial quantum entanglement configurations in industrial applications is important part of the effort to better understand complex quantum entanglement and harness its non-classical, non-local power. This as shown in the description of the invention can to lead identification of important practical features, that can be then used as a basis for definition of new quantum information processing and communication applications, such as the demonstrated novel Entanglement QRNG protocol with the publicly verifiable randomness.

In view of industrial applications another important feature is also the property of the proposed generalized entanglement QRNG protocols (with four or more entangled qubits) to use shorter sequences of random bits verified statistically to be truly random in order to information theoretically certify same randomness of longer sequences of bits remaining secret, which is a result of fundamental significance.

One should also add that the proposed Entanglement QRNG protocol with it's main feature towards publicly verified absolute randomness not sacrificing it's secrecy, possible due to a secret correlation—anticorrelation relation on subsequent bits positions of both random bit sequences (one kept secret, and the other one revealed) establishes a connection with the device independent security concept in field of industrially applied quantum communication, first proposed in 1998-1999 for QKD [78]. The device independent security QRNGs (or device independent quantum randomness) concept relates to the idea of abstracting two independent issues in quantum engineering, namely the theoretical model of a quantum system and it's practical implementation, which suffers shortcomings related to the overlap of two fundamentally different physical domains, i.e. quantum and classical ones (with the latter domain required to male practical use of quantum systems, i.e. to implement deterministicly a qubit model within a needed for the absolute randomness maximally symmetrical linear combination yielding a truly random result with exactly ½ probability within also by definition classically implemented quantum measurement). In a simple case of non-entanglement QRNG protocol the device independent true randomness is meant to provide for a combined post-processing on the QRNG generated bit sequence aimed at abstracting it's verifiable true randomness from the particularities of the quantum mechanical system and measurement implementation. In other words the theoretical model of such a non-entanglement QRNG can be defined as a symmetrical, maximally non-orthogonal state of a qubit

$$\frac{1}{\sqrt{2}} \vert 0 〉 + \frac{1}{\sqrt{2}} \vert 1 〉$$

with a result of measurement being classical bit 0 or 1 each with the probability equal to exactly ½ according to the von Neumann quantum measurement postulate. This situation however in practical implementation can deviate from the model by n the pure quantum state (changing the qubit superposition coefficients to slightly different then

$$\frac{1}{\sqrt{2}} ,$$

but still following the norm condition for a quantum pute state) or even departing the pure state towards a mixed state (which indeed is a realistic scenario taking into account that it is impossible to ideally isolate the system from the external interaction, and therefore this systems will entangle with the degrees of freedom of the surroundings). For such realistic scenarios the device independence comes into action, with the idea to abstract the particularities of the quantum process involved (and its shortcomings) to a black-box. Such a black-box if deemed to be in a perfect implementation of quantum engineering would indeed generate true random bit sequence. If it is non-entangled QRNG then the black-box is a single register of qubits, upon which subsequent measurements are performed and the output of the QRNG black-box yields the sequence of the classical bits. Device independence putting to abstract the terms of how exactly the quantum mechanic system had generated these classical bits only focuses on making sure upon statistical procedures that these bits are truly random (within post-processing of the generated classical bits sequence). Therefore a QRNG system combining both the quantum black-box and the system for post-processing of the generated classical bits (in most trivial case only verifying upon stringest classical measures the level of randomness of the generated bits sequence, that it is really random, thus by measuring entropies of the subsequent bits positions and the entropy of the subsequences as well as the whole sequence which includes finding of possible patterns, and testing the deviation from the statistical model with entropies on each bit being as little deviated from 1 as possible—which is usually achieved by employing the standardized tests of randomness issued by independent mathematicians [79] or standards and certification organizations [42] basing their standards on mathematics advancements. There are two main important problems of the black-box approach in the device independent quantum randomness generation, i.e. 1) a necessity to reveal the secrecy of the random bits sequence of it's randomness is to be proven to external observers and 2) a possibility that the black-box is leaking the quantum information, that can be achieved by adversary entangling qubits in his disposal with the qubits used in QRNG black-box to generate randomness. Both situations can be resolved with the proposed protocol of entanglement QRNG, because if the black-box is operating on the maximally entangled Bell states for qubits (i.e. It operates on two registers of qubits mutually entangled in one of either correlated or anticorrelated perfect Bell state at each corresponding registers' position, rather than on a single qubits register), than 1) the randomness verification by the external parties within the post-processing of the one of the generated bits sequence (e.g. departing the black-box and being published) can be performed without the need to reveal the other sequence.

Also in view of related problems of the device independent security of QRNG is the adverse situation that the quantum black-box constituting QRNG core device can leak quantum information in form of entanglement (this is referred to as the side-channel). In our protocol this situation is fully eliminated by the theoretical construct of the protocol itself which requires quantum Bell states exchanged between the parties—such states are by the definition maximally entangled and therefore cannot share any entanglement with external quantum states due to algebraical tensor product properties in Hilbert spaces within the quantum mechanics foundations (thus effectively excluding any additional co-entangled qubits hypothetically under control by an adversary). Of course this is only idealistic (i.e. theoretical) protocol definition and practical implementations of it are doomed to fall shortcoming of this one assumption of pure Bell states, most importantly due to unavoidable decoherence interfering with both the spacial distribution of entangled quantum states as well as their temporal storing (a less relevant problem here in direct application). For space distribution of entanglement, decoherence can be overcome with the concept of the quantum repeater [80] in a chain-like segmented linear or hierarchical quantum channel (based on the entanglement swapping protocol [81] or more generally on quantum teleportation [82]), while the temporal storing is of course associated with the quantum memories (the problem of temportal storing of entangled states—despite not being the key criteria for the proper implementation of the entanglement QRNG protocol, as the entangled subsystems—individual qubits, can be measured on the fly right after being spatially distributed—or in view of the fact that generally the simplest quantum memory can be thought of a closed path spatial distribution quantum channel, especially for the qubits being photons, and thus the time vs space coherence is less divided—is however important, as quantum memories do play important role in quantum repeaters themselves). Even if the distribution of purely entangled qubits would not be possible to be achieved in the protocol QRNG implementation (the first quantum repeater successful implementation has been demonstrated in 2007 [83, 84] but is not perfect and still under development, e.g. [85]), yet there exists procedures such as entanglement distillation (or entanglement purification, investigated both theoretically [86-88] and experimentally [89-92]) schemes that can be used to achieve the desired result of effectively sharing only pure Bell states (condition by required feasibility of quantum local operations), thus eliminating any possible quantum information leakage (that would must have been in the form of entanglement). Therefore the basic assumption of our entanglement QRNG protocol of the Bell states sharing (requiring noiseless quantum channel) is theoretically obtainable by the entanglement distillation satisfying this requirement and effectively providing the noiseless quantum channel for sharing of maximally entangled qubits (the entanglement distillation effectively transforms a number of arbitrarily (not purely) entangled states into smaller number of arbitrarily pure Bell pairs by quantum local operations and classical communication (LOCC) only, thus compensating decoherence of noisy quantum channels and transforming these channels into noiseless, yet with lower time rates of qubits exchange efficiencies and by the cost of the quantum information processing necessity.

It should be noted that apart from the above explained scenario for utilization of randomly selected either correlated or anti-correlated Bell states on subsequent qubits' register positions in the entanglement QRNG protocol for a proof of it's true randomness there exist also a simple extension of the proposed protocol, generalizing possible application to the cryptographic procedure known as secret splitting or secret sharing [93]. The proposed entanglement QRNG protocol based upon opposite Bell states correlations is the most simple solution to the secret splitting problem, enabled if we assume, that the randomly correlated and anti-correlated Bell states are shared between Bob and Charlie, while Alice (and only her) knows exactly on which positions of the qubits' register Bob and Charlie share these either correlated or anti-correlated maximally entangled qubits. How to achieve this situation to guarantee that only Alice has this knowledge? It should be noted that in the original our proposition the selection of correlated or anti-correlated Bell states for the QRNG protocol is fully random and this information is not available to other parties. If we assume that this happens under control of Alice she can keep this knowledge a secret and then send her two registers of mutually maximally entangled qubits to Bob and Charlie without any other information. This secret of Alice is in either of the form of a random classical bit sequence (random secret) or in the form of some meaningful information (secret message) that she would want to define as a secret to be splitted between Bob and Charlie. After Alice distributes the correlated and anticorrelated qubits in known only to her positions between Bob and Charlie, both Bob and Charlie share entangled Bell pairs of qubits, but each of them has completely no information on which positions are occupied by respectively correlated or anti-correlated pairs. If either Bob and Charlie runs his QRNG procedure by measuring his corresponding qubits' register and obtains a truly random classical sequence of bits, his counter-party's entangled qubits' register is projected (upon the von Neuman quantum measurement) to states that will deterministicly unveil upon future measurement a classical bit sequence in this very special correlation and anti-correlation relation on given bits positions, known only to Alice but not to them. Let's assume that Bob had measured his qubits, and obtained a secret random bit sequence, then Charlie upon performing his measurement also obtains a truly random bit sequence, however specifically correlated to Bob's bits sequence. This very correlation/anti-correlation configuration of two truly random bit strings of Bob's and Charlie's is carrying the split (or shared) secret of Alice between Bob and Charlie. Due to a true randomness of the sequences of both Bob and Charlie, guaranteed by quantum mechanics laws and the symmetry of entangled Bell states, neither of them has any information about this correlation (Alice's secret) until they join and compare both their bits sequences, what will instantly reveal Alice's secret to them. The basic application scenario of such protocol is to secure e.g. critical control system (such as nuclear weapons control as was a known practice on intercontinental ballistic missiles submarines with two physical keys for the captain and the first officer) or in a generalization of this scheme to n parties for more advanced cryptographic applications, such as some paradigms of virtual crypto-currencies.

Due to theoretically proofed randomness in Bob's and Charlie's QRNG generated bits sequences carrying together Alice's secret, it's impossible to gain any information on the secret from any possible and even technology independent attack performed by Bob or Charlie separately on their sequences, which is in contrary to the original classical secret sharing protocol, conditioned computationally [93]. The quantum secret sharing protocols discussed later [94] do not discuss a simplest possible scenario as presented above. It should be emphasized also that the extension of the proposed correlation/anti-correlation entanglement QRNG protocol for secret sharing problem has symmetry property: it is fully symmetric between the 3 parties. Each party's sequence of bits is known only to this party and secret to all others. Each pair of the 3 parties can thus combine their 2 secrets and in instant obtain a secret of the remaining party, in contrary to other quantum secret sharing protocols. Our proposed extension of the entanglement QRNG protocol based on the generalized Bell states towards secret sharing can be also much more intuitively generalized to n parties than is a case with the previously proposed quantum secret sharing schemes.

One more interesting take on this kind of application of entanglement based QRNG defined upon correlated and anti-correlated Bell states towards secret sharing cryptographic problem is to further investigate the case in which Alice's secret is not a meaningful message, but rather a truly random bits string.

This idea can lead to another concept of application of the distributed entangled QRNG generator. In this case we can assume two QRNG devices each operating on a single quantum register, but being in entanglement with the register of qubits in it's coupled counterpart. There are 2 main cases possible. For the first case, let's assume that these two devices are operated only by Alice and Bob and that only Alice knows which positions on the qubits registers are fully correlated and which are fully anticorrelated Bell states (this means that Alice loads both QRNG devices with entanglement, and then hands Bob one of the devices). It doesn't matter which of the parties performs their measurements first, both of them will have perfectly random strings, but only Alice will know exactly how both classical bits strings are correlated and anti-correlated (thus she will essentially know the string of Bob, but Bob won't know Alice's string). If Alice is publicly trusted institution, she can publish her random bits string coupled to Bob's string but unknowingly how to all else and perform public post-processing of her revealed string, proving (in a most trivial form of the device independent security) that Bob's random string is indeed truly random (Alice won't reveal her information on the way how her bits were coupled to Bob's and thus Bob's sequence will remain secret, while proven to be truly quantumly random).

The first issue arising is how Alice can make sure that the selection of correlation vs. anticorrelation is truly random. The answer is she cannot unless she is using a perfect QRNG to this end. So the more generalized situation is in the 3-parties scenario. If there are Alice, Bob and Charlie, we can assume that all of them share generalized 3-qubits entangled Bell states (in engineering terms they share 3 QRNG devices each of them storing a register of qubits, and each qubit is in the one chosen state of the generalized 3-qubits Bell basis). This state is in the such linear superposition that upon it's measurement by Alice, she will instantly project the states of Bob's and Charlie's qubit with exactly ½ probability to either correlated or anti-correlated Bell state. It is important to mention that by doing this Alice will have also a truly random bits sequence on her own (not known to both Charlie and Bob and this stage, as well as to anyone else). This will now guarantee also that Bob and Charlie share truly random distribution of correlated and anticorrelated Bell states in their QRNG devices. Upon their measurement (by either party) Bob and Charlie will now both have truly random bits strings adequately correlated and anti-correlated (in a manner known by Alice but not by anyone else, including Bob and Charlie before their compare their strings). This scenario is thus the basis of the distributed randomness generation related to the simple solution of the shared secret (or split secret) cryptographic problem, because each pair (Alice-Bob, Bob-Charlie or Alice-Charlie) can now combine their bits sequence revealing the sequence of the third party. However this extension is also representing the distributed quantum randomness generation because now it is enough that Alice (alone by herself, as a trusted institution) will publish the random string sequence and in this way she will prove that both random sequences used by Bob and Charlie are truly random (yet unknown to the public). This proof is of course conditioned by the ability to prove in the first place that all the 3 parties had their maximally entangled Bell states distributed to their respective devices, as well as in the previous paragraph to prove that the share Bell states are really Bell states, and this is the second important issue. As the most trivial solution to this second issue, it's possible that the involved parties (Alice, Bob, Charlie for the latter case or just Alice and Bob for the former) will measure and reveal e.g. 99

How Bob and Charlie will use their random sequences in the latte scenario is another question, but the best option they have in terms of security is that one of them discards their string completely and only the other one will use it (they can reiterate the whole procedure and discard their strings by turns, which will guarantee that in all sessions each of them will use a secret but publicly proven to be fully random bits sequence).

A critique of similarity to the above presented application in Its extension towards secret sharing (or secret splitting) could be based upon the mentioned publication [94], which uses 3-qubits GHZ entangled states to solve the secret sharing cryptographic problem. In this original and non-trivially, however differently formulated approach to a secret sharing, based on a then novel theme of GHZ state (described shortly before) a measurement of one qubit of GHZ entangled state is proposed to be carried out by both Alice and Bob in the maximally non-orthogonal basis |+ [symbol] , |− [symbol] what only after measuring of the 2 qubits out of GHZ state's 3 qubits would project the remaining one qubit of Charlie into state |+ [symbol] or |− [symbol] (the projection would yield |+ [symbol] if Alice and Bob obtained same results, i.e. either |++ [symbol] or |−− [symbol] and |− [symbol] for the case of different Alice's and Bob's outcomes |+− [symbol] and |−+ [symbol] ). This subtle difference in the protocol is based upon changing the basis of the measurement to the |+ [symbol] , |− [symbol] (along x and y axes in more detailed formulation of the protocol) In relation to the originally defined GHZ state in the standard basis |0 [symbol] , |1 [symbol] . This difference on the first glance can be considered non-relevant, however it should be noted that changing of the measurement basis, quietly introduces into the quantum protocol a very classical factor: i.e. a fundamental impossibility to classically implement a perfect change of the basis from originally defined {|0 [symbol] , |1 [symbol] } to the maximally non-orthogonal basis {|+ [symbol] , |− [symbol] }—as it is a classical device rotation problem, it's resolution will be always fundamentally limited. This problem does not affect situation when the entangled state has been prepared in the standard basis {|0 [symbol] , |1 [symbol] } because this basis is not changed for the measurement.

It should be stressed that the proposed invention has also a possible modification towards implementing a multi-party topology quantum key distribution (QKD), trivially evident when one considers a GHZ state shared between 3 parties (or generalized n-qubit GHZ state shared between n parties). Recent propositions [95-97] discuss different related scenarios and associated protocols in detail, however it is important in the context of discussing our proposed entanglement QRNG protocol to mention the simplest construct of n-to-n topology QKD based upon GHZ 3-qubit state: i.e. to split a GHZ state between 3 parties (or a generalized GHZ state between n parties). If the 3 (n) parties share the perfect GHZ states (or generalized GHZ states in case o n parties) in the GHZ state of full correlation

$$\frac{1}{\sqrt{2}} ( \vert 000 〉 + \vert 111 〉 )$$

(or it's n-qubit generalization) the obvious application will be generating of a shared by all parties, identical classical keys (or random bits sequences). Upon measuring by one of the parties own qubits (doesn't matter by which party) all the qubits shared by remaining parties will be projected to classical information fully correlated with the classical outcomes of the measuring party. This results in an instant sharing of the same classical and secret key between 3 (or n) parties in the protocol. This key is shared by all the parties but fully unknown to all external parties if assumption of sharing really perfect GHZ states holds.

### LITERATURE

[1] Alain Aspect, Philippe Grangier, and Gerard Roger. Experimental tests of realistic local theories via Bell's theorem. Phys. Rev. Lett., 47:460463, 1981.
[2] Alain Aspect, Philippe Grangier, and Gerard Roger. Experimental realization of EinsteinPodolskyRoenBohm gedanken experiment: A new violation of Bell's inequalities. Phys. Rev. Lett., 49:91-94, 1982.
[3] A. Einstein, B. Podolsky, and N. Rosen. Can quantum-mechanical description of physical reality be considered complete?Phys. Rev., 47:777-780, 1935.
[4] John Bell. On the Einstein Podolsky Rosen paradox. Physics, 1:195200, 1964.
[5] John F. Clauser, Michael A. Horne, Abner Shimony, and Richard A. Holt. Proposed experiment to test local hidden-variable theories. Phys. Rev. Lett., 23:880-884, 1969.
[6] N. J. Cerf and C. Adami. Negative entropy and information in quantum mechanics. Phys. Rev. Lett., 79:5194-5197, 1997.
[7] Michal Horodecki, Jonathan Oppenheim, and Andreas Winter. Partial quantum information. Nature, 436:673, 2005.
[8] Charles H. Bennett and Stephen J. Wiesner. Communication via one- and two-particle operators on Einstein-Podolsky-Rosen states. Phys. Rev. Lett., 69:2881-2884, 1992.
[9] Wojciech Hubert Zurek. Decoherence, einselection, and the quantum origins of the classical. Rev. Mod. Phys., 75:715-775, 2003.
[10] L. Jacak, J. Krasnyj, W. Jacak, R. Gonczarek, and P. Machnikowaki. Unavoidable decoherence in semiconductor quantum dots. Phys. Rev. B, 72:245309, 2005.
[11] Peter W. Shor. Scheme for reducing decoherence in quantum computer memory. Phys. Rev. A, 52:R2493-R2496, 1995.
[12] A. Borras, A. P. Majtey, A. R. Plastino, M. Casas, and A. Plastino. Robustness of highly entangled multiqubit states under decoherence. Phys. Rev. A, 79:022108, 2009.
[13] Paolo Zanardi and Seth Lloyd. Topological protection and quantum noiseless subsystems. Phys. Rev. Lett., 90:067902, 2003.
[14] Sankar Das Sarma, Michael Franan, and Chetan Nayak. Topologically protected qubits from a possible non-abelian fractional quantum hall state. Phys. Rev. Lett., 94:166802, 2005.
[15] Chetan Nayak, Steven H. Simon, Ady Stern, Michael Freedman, and Sankar Des Sarma. Non-abelian anyone and topological quantum computation. Rev. Mod. Phys., 80:1083-1159, 2008.
[16] A. Yu. Kitaev. Fault-tolerant quantum computation by anyone. Annals of Physics, 303:2-30, 2003.
[17] Alain Aspect, Philippe Grangier, and Gerard Roger. Experimental realisation of EinsteinPodolskyRosenBohm gedanken experiment: A new violation of Bell's inequalities. Phys. Rev. Lett., 49:91-94, 1982.
[18] Alain Aspect, Philippe Grangier, and Gerard Roger. Experimental tests of realistic local theories via Bell's theorem. Phys. Rev. Lett., 47:460-463, 1981.
[19] P. K. Aravind. Borromean entanglement of the ghz state. In M. Horne R. S. Cohen and J. Stachel, editors, Potentiality Entanglement and Passion-at-a-Distance: Quantum Mechanical Studies for Abner Shimony, pages 53-59. Kluwer Academic Publishers, Dordrecht, 1997.
[20] Louis H Kauffman and Samuel J Lomonaco Jr. Quantum entanglement and topological entanglement. New J. Phys., 4:73.1-73.18, 2002.
[21] A. Sugita. Borromean entanglement revisited. Ar Xiv e-prints, 2007.
[22] Albert Einstein and Nathan Rosen. The particle problem in the general theory of relativity. Phys. Rev., 48:73-77, 1935.
[23] Michael S. Morris, Kip S. Thorne, and Ulvi Yurtsever. Wormholes, time machines, and the weak energy condition. Phys. Rev. Lett., 61:1446-1449, 1988.
[24] H. Schmidt. Quantum-mechanical random-number generator. J. Appl. Phys., 41:462-468, 1970.
[25] Frank Wilczek. Quantum mechanics of fractional-spin particles. Phys. Rev. Lett., 49:957-959, 1982.
[26] J. Jacak, I. Jóźwiak, and L. Jacak. New implementation of composite fermions in terms of subgroups of a braid group. Phys. Lett. A, 374:346-350, 2009.
[27] J. Jacak, R. Goncsarek, L. Jacak, and I. Jóźwiak. Application of braid groups in 2D Hall system physics: composite fermion structure. WorldScientific, Singapore, 2012.
[28] Janusz Jacak. Unconventional fractional quantum hall effect in bilayer graphene. Sci. Rep., 7:8720, 2017.
[29] J. S. Birman. Braids, Links and Mapping Class Groups (AM-82), Volume 82. Princeton UP, Princeton, 1974.
[30] D. M. Greenberger, M. A. Horne, and Zeilinger A. Going Beyond Bells Theorem. Springer, Dordrecht, 1989.
[31] W. D ur, G. Vidal, and J. I. Cirac. Three qubits can be entangled in two inequivalent ways. Phys. Rev. A, 62.062314, 2000.
[32] P. R. Cromwell, E. Beltrami, and M. Rampichini. The borromean rings. Math. Intelligencer, 20.53-62, 1998.
[33] Ch. Bennett, H. Bernstein, S. Popescu, and B. Schumacher. Concentrating partial entanglement by local operations. Phys. Rev. A, 53:2046-2052, 1996.
[34] Ch. Bennett, G. Brassard, S. Popescu, B. Schumacher, J. Smolin, and W. Wooters. Purification of noisy entanglement and faithful teleportation via noisy channels. Phys. Rev. Lett., 76:722-725, 1996.
[35] Ch. Bennett, D. D. DiVincenzo, J. Smolin, and W. Wooters. Mixed state entanglement and quantum error correction. Phys. Rev. A, 54:3824-3851, 1996.
[36] N. David Mermin. Physics: QBism puts the scientist back into science. Nature, 507:421-423, 2014.
[37] Christopher A. Fuchs and R'udiger Schack. Quantum-Bayesian coherence. Rev. Mod. Phys., 85:1693-1715, 2013.
[38] Andrei Khrennikov. Randomness: quantum versus classical. Int. J. Quantum Inform., 14:1640009, 2016.
[39] Matej Pivoluska and Martin Plesch. Device independent random number generation. Acta Phys. Slovaca., 64:600-663, 2014.
[40] Xiongfeng Ma, Xiao Yuan, Zhu Cao, Bing Qi, and Zhen Zhang. Quantum random number generation. Quantum Inf., 2:16021, 2016.
[41] W. K. Wootters and W. H. Zurek. A single quantum cannot be cloned. Nature, 299:802803, 1982.
[42] Andrew Rukhin, Juan Soto, James Nechvatal, Miles Smid, Elaine Barker, Stefan Leigh, Mark Levenson, Mark Vangel, David Banks, Alan Heckert, James Dray, and San Vo. A statistical test suite for random and pseudorandom number generators for cryptographic applications. Natl. Inst. Stand. Technol. Spec. Publ., 2010. 800-22rev1a http://nvlpubs.nist.gov/nistpubs/Legacy/SP/nistpecialpublication800-22rla.pdf.
[43] N. Nisan and A. To-Shma. Extracting randomness: a survey and new constructions. J. Comp. Sys. Sci., 58:148-173, 1999.
[44] D. Frauchiger, R. Renner, and M. Troyer. True randomness from realistic quantum devices. Ar Xiv e-prints, 2013. arXiv:quant-ph/1311.4547.
[45] X. Ma, F. Xu, H. Xu, X. Tan, B. Qi, and H.-K. Lo. Postprocessing for quantum random-number generators: Entropy evaluation and randomness extraction. Phys. Rev. A, 87:062327, 2013.
[46] Akshata Shenoy-Hejamadi, Anirban Pathak, and Srikanth Radhakrishna. Quantum cryptography: Key distribution and beyond. Quanta, 6:1-47, 2017.
[47] S. Pironao, A. Acín, S. Massar, A. Boyer de la Giroday, D. N. Matsukevich, P. Mauna, S. Olmschenk, D. Hayes, L. Luo, T. A. Manning, and C. Monroe. Random numbers certified by Bells theorem. Nature, 464:1021-1024, 2010.
[48] B. G. Christensen, K. T. McCusker, J. B. Altepeter, B. Calkins, T. Gerrits, A. E. Lita, A. Miller, L. K. Shalm, Y. Zhang, S. W. Nam, N. Brunner, C. C. W. Lim, N. Gisin, and P. G. Kwiat. Detection-loophole-free test of quantum non-locality, and applications. Phys. Rev. Lett., 111:130406, 2013.
[49] Tommaso Lunghi, Jonatan Bohr Brask, Charles Ci Wen Lim, Quentin Lavigne, Joseph Bowles, Anthony Martin, Hugo Zbinden, and Nicolas Brunner. Self-testing quantum random number generator. Phys. Rev. Lett., 114:150501, 2015.
[50] Mark Hillery, Vladimír Bu\grave{z}ek, and André Berthiaume. Quantum secret sharing. Phys. Rev. A, 59:1829-1834, 1999.
[51] M. Nielsen and I. Chuang. Quantum computation and quantum information. Amer. J. of Phys., 70:558, 2002.
[52] Xi-Lin Wang, Luo-Kan Chen, W. Li, H.-L. Huang, C. Liu, C. Chen, Y.-H. Luo, Z.-E. Su, D. Wu, Z.-D. Li, H. Lu, Y. Hu, X. Jiang, C.-Z. Pang, L. Li, N.-L. Liu, Yu-Ao Chen, Chao-Yang Lu, and Jian-Wei Pan. Experimental ten-photon entanglement. Phys. Rev. Lett., 117:210502, 2016.
[53] D. M. Zajac, A. J. Sigillito, M. Russ, F. Borjans, J. M. Taylor, G. Burkard, and J. R. Petta. Resonantly driven CNOT gate for electron spins. Science, 2017.
[54] Serge Rosenblum, Yvonne Y. Gao, Philip Reinhold, Chen Wang, Christopher J. Aline, Luigi Frunzio, Steven M. Girvin, Liang Jinag, Masyar Mirrahimi, Michel H. Devoret, and Robert J. Schoelkopf. A CNOT gate between multiphoton qubits encoded in two cavities. ArXiv e-prints, 2017. arXiv:1709.05425 [quant-ph].
[55] Yan Liang, Chong Song, Xin Ji, and Shou Zhang. Fast CNOT gate between two spatially separated atoms via shortcuts to adiabatic passage. Opt. Express, 23:23798-23810, 2015.
[56] Cristian Bonato, Floran Haupt, Sumant S. R. Oemrawsingh, Jan Gudat, Dapeng Ding, Martin P. van Exter, and Dirk Bouwmeester. Cnot and bell-state analysis in the weak-coupling cavity qed regime. Phys. Rev. Lett., 104:160503, 2010.
[57] L. Isenhower, E. Urban, X. L. Zhang, A. T. Gill, T. Henage, T. A. Johnson, T. G. Walker, and M. Sefman. Demonstration of a neutral atom controlled-not quantum gate. Phys. Rev. Lett., 104:010503, 2010.
[58] J. H. Plantenberg, P. C. de Groot, C. J. P. M. Harmana, and J. E. Mooij. Demonstration of controlled-NOT quantum gates on a pair of superconducting quantum bits. Nature, 447:836, 2007.
[59] Li-Ping Deng, Haibo Wang, and Kaige Wang. Quantum CNOT gates with orbital angular momentum and polarization of single-photon quantum logic. J. Opt. Soc. Am. B, 24:2517-2520, 2007.
[60] Z. Zhao, A.-N. Zhang, Y.-A. Chen, H. Zhang, J.-F. Du, T. Yang, and J.-W. Pan. Experimental demonstration of a nondestructive controlled-NOT quantum gate for two independent photon qubits. Phys. Rev. Lett., 94:00501, 2005.
[61] Marco Florentino and Franco N. C. Wong. Deterministic controlled-not gate for single-photon two-qubit quantum logic. Phys. Rev. Lett., 93:070502, 2004.
[62] Sara Gasperoni, Jian-Wei Pan, Philip Walther, Terry Rudolph, and Anton Zeilinger. Realisation of a photonic controlled-not gate sufficient for quantum computation. Phys. Rev. Lett., 93:020504, 2004.
[63] Kae Nemoto and W. J. Munro. Nearly deterministic linear optical controlled-not gate. Phys. Rev. Lett., 93:250502, 2004.
[64] Ferdinand Schmidt-Kaler, Hartmut Häffner, Mark Riebe, Stephan Guide, Gavin P. T. Lancaster, Thomas Deuschle, Christoph Becher, Christian F. Roos, Jürgen Eschner, and Rainer Blat. Realization of the Cirac-Zoller controlled-NOT quantum gate. Nature, 422:408, 2003.
[65] T. B. Pittman, M. J. Fitch, B. C Jacobs, and J. D. Franson. Experimental controlled-not logic gate for single photons in the coincidence basis. Phys. Rev. A, 68:032316, 2003.
[66] J. L. O'Brien, G. J. Pryde, A. G. White, T. C. Ralph, and D. Branning. Demonstration of an all-optical quantum controlled-NOT gate. Nature, 426:264, 2003.
[67] D. DeMille. Quantum computation with trapped polar molecules. Phys. Rev. Lett., 88:067901, 2002.
[68] Andrea Crespi, Roberta Ramponi, Roberto Osellame, Linda Sansoni, Irene Bongioanni, Fabio Sciarrino, Giuseppe Vallone, and Paolo Mataloni. Integrated photonics quantum gates for polarization qubits. Nat. Commun., 2:566, 2011.
[69] L. Sansoni. Quantum computation: Integrated quantum gates for polarization encoded qubits. In Integrated Devices for Quantum Information with Polarization Encoded Qubits, pages 57-63. Springer, Cham, 2014.
[70] G. Ross. Grand Unified Theories (Frontiers in Physics). Westview Press, Boulder, 1984.
[71] H. Georgi and S. L. Glashow. Unity of all elementary particle forces. Phys. Rev. Lett., 32:438-441, 1974.
[72] M. Van Raamsdonk. Building up spacetime with quantum entanglement. Gen. Rel. Grav., 42:2323-2329, 2010.
[73] B. Swingle. Entanglement renormalization and holography. Phys. Rev. D, 86:065007, 2012.
[74] F. Pastawaki, B. Yoshida, D. Harlow, and J. Preskill. Holographic quantum error-correcting codes: toy models for the bulk/boundary correspondence. J. High Energ. Phys., 2015:149, 2015.
[75] D. Stanford and L. Susskind. Complexity and shock wave geometries. Phys. Rev. D, 90:126007, 2014.
[76] R. Cowen. The quantum source of space-time. Nature, 527:290-293, 2015.
[77] L. Susskind. Copenhagen vs Everett, teleportation, and er=epr. Fortschritte der Physik, 64:551-564, 2016.
[78] Hoi-Kwong Lo and H. F. Chau. Unconditional security of quantum key distribution over arbitrarily long distances. Science, 283:2050-2056, 1999.
[79] G. Marsaglia. The Marsaglia random number CDROM including the Diehard battery of tests of randomness. Florida State University, 1995.
[80] H.-J. Briegel, W. Dür, J. I. Cirac, and P. Zoller. Quantum repeaters: The role of imperfect local operations in quantum communication. Phys. Rev. Lett., 81:5932-5935, 1998.
[81] M. Zukowski, A. Zeilinger, M. A. Horne, and A. K. Ekert. “event-ready-detectors” bell experiment via entanglement swapping. Phys. Rev. Lett., 71:4287-4290, 1993.
[82] Charles H. Bennett, Gill. Brassard, Claude Crépeau, Richard Jozsa, Asher Per, and William K. Wootters. Teleporting an unknown quantum state via dual classical and Einstein-Podolsky-Rosen channels Phys. Rev. Lett., 70:1895-1899, 1993.
[83] Zeng-Bing Chen, Bo Zhao, Yu-Ao Chen, Jörg Schmiedmayer, and Jian-Wei Pan. Fault-tolerant quantum repeater with atomic ensembles and linear optics. Phys. Rev. A, 70:022329, 2007.
[84] Zhen-Sheng Yuan, Yu-Ao Chen, Bo Zhao, Shuai Chen, Jörg Schmiedmayer, and Jian-Wei Pan. Experimental demonstration of a BDCZ quantum repeater node. Natnae, 454:1098, 2008.
[85] Bikaeh K. Behera, Swarnadeep Seth, Antariksha Das, and Prasanta K. Panigrahi. Experimental demonstration of quantum repeater in IBM quantum computer. ArXiv e-prints, 2017. arXiv:1712.00854v1 [quant-ph].
[86] Charles H. Bennett, Herbert J. Bernstein, Sandu Popescu, and Benjamin Schumacher. Concentrating partial entanglement by local operations. Phys. Rev. A, 53:2046-2052, 1996.
[87] Charles H. Bennett, Gilles Brassard, Sandu Popescu, Benjamin Schumacher, John A. Smolin, and William K. Wootters. Purification of noisy entanglement and faithful teleportation via noisy channels Phys. Rev. Lett., 76:722-726, 1996.
[88] Charles H. Bennett, David P. DiVincenzo, John A. Smolin, and William K. Wootters. Mixed-state entanglement and quantum error correction. Phys. Rev. A, 54:3824-3851, 1996.
[89] Paul C. Kwiat, Salvador Barraza-Lopez, André Stefanov, and Nicolas Gisin. Experimental entanglement distillation and ‘hidden’ non-locality. Nature, 409:1014, 2001.
[90] J.-W. Pan, C. Simon, C. Brukner, and A. Zeilinger. Entanglement purification for quantum communication. Nature, 410:1067, 2001.
[91] Takashi Yamamoto, Masato Koashi, Sahin Kaya Özdmnir, and Nobuyuki Imoto. Experimental extraction of an entangled photon pair from two identically decohered pairs. Nature, 421:343, 2003.
[92] Jian-Wei Pan, Sara Gasparoni, Rupert Ursin, Gregor Weihs, and Anton Zeilinger. Experimental entanglement purification of arbitrary unknown states. Nature, 423:417, 2003.
[93] Adi Shamir. How to share a secret. Commun. ACM, 22:612-613, 1979.
[94] Mark Hillery, Vladimír Bu\grave{z}ek, and André Berthiaume. Quantum secret sharing. Phys. Rev. A, 59:1829-1834, 1999.
[95] Michael Epping, Hermann Kampermann, Chiara Macchiavello, and Dagmar Bru. Multi-partite entanglement can speed up quantum key distribution in networks. New Journal of Physics, 19:093012, 2017.
[96] Jérŕmy Ribeiro, Gláucia Murta, and Stephanie Wehner. Fully device independent Conference Key Agreement. ArXiv e-prints, 2017. arXiv:1708.00798v1 [quant-ph].
[97] Mehul Malik Matej Pivoluska, Marcus Huber. Layered quantum key distribution. ArXiv e-prints, 2017. arXiv:1709.00377v2 [quant-ph].

1. The invention of the Entanglement Quantum Random Number Generator with public verification of randomness is based upon the originally proposed entanglement based random correlation generator, assuring that generated random sequences are randomly correlated and anti-correlated on corresponding positions: in the most basic configuration of the device its main feature is publicly verified absolute randomness not sacrificing it's secrecy, possible due to a secret correlation—anticorrelation relation on subsequent bits positions of both random bit sequences (one kept secret, and the other one revealed).

2. The described invention of the Entanglement Quantum Random Number Generator with public verification of randomness offers for the first time in history a technical solution to provide a publicly accessible proof of privately and secretly generated randomness without compromising its privacy and secrecy, thus allowing an external party to freely and publicly verify the randomness of the generated sequence without disclosing of its secrecy or distorting it in any way. This feature of QRNG is proposed for the first time in randomness generation technical field and has an important role for applications in both quantum and classical cryptography as specified in the description of the invention.

3. The new important properties of the proposed Entanglement QRNG with certified proof of randomness invention find applications in many areas of technology and science where randomness is needed. These unique properties are strongly linked with multiple qubits entangled states and their topological features. The have crucial applicability in the industry of information and communication security. The invention uses non-trivial quantum entanglement configuration in industrial applications harnessing its non-classical and non-local power, which leads to identification of not achieved previously practical features of public verification of true randomness (certified randomness proof) without disposing of the secrecy of the very proven-random sequence.

4. The main advantage in contrast to standard QRNG protocol is that all previously considered schemes did not offer any mean of public verification of true randomness keeping secrecy of the generated random number. This is very critical issue in terms of applications as potential users of QRNGs must rely on trust assumption, not being able to offer verification of the very randomness used without revealing it. The proposed invention and its generic implementing device (shown in the FIG. 3 with workflow diagram depicted in the FIG. 4) solve this issue by enabling objective verification of the true randomness of the bit sequence, without compromising its secrecy.

5. The generalised extension of the invented device of Entanglement QRNG (as presented in FIG. 5 and FIG. 6, with four or more entangled qubits) uses shorter sequences of random bits verified statistically to be truly random in order to information theoretically certify same randomness of longer sequences of bits remaining secret. This result has not been achieved before in the field of randomness generation and is of a fundamental significance for the described invention.
